(19) United States
(12) Patent Application Publication
(10) Pub. No.: US 2019/0126299 A1
(43) Pub. Date: May 2, 2019

(54) SYSTEM AND PROCESS FOR COATING PROFILES

(71) Applicant: SAT (SURFACE ALUMINUM TECHNOLOGIES) S.R.L., Verona (IT)

(72) Inventor: Silvio Maria Trevisan, Verona (IT)

(21) Appl. No.: 16/091,093

(22) PCT Filed: Mar. 31, 2017
(86) PCT No.: PCT/EP2017/057655

§ 371 Date: Oct. 3, 2018

(30) Foreign Application Priority Data
Apr. 5, 2016 (NL) 102016000034943

(51) Int. Cl. B05B 5/08; B05B 12/08; B05B 12/12; B05B 13/02; B05D 1/06

(52) U.S. Cl. CPC B05B 5/081; B05B 12/08; B05D 1/06; B05B 13/0264; B05B 12/122

(57) ABSTRACT

A system for coating profiles comprises several treatment stations for treating the profiles, including at least one coating station for coating the profiles, the station being equipped with spray guns for dispensing the electrostatically charged powder coating. The system further comprises first detection means for detecting first data concerning the dimensions and shape of said profiles, first storage media for storing second data concerning said powder coating, which shall be used for coating said profiles, second storage media for storing third data concerning a set of sample profiles, and comparison means for comparing said first, second and third data so as to generate commands adapted to vary the operating parameters for said guns.

### CROSS-REFERENCE TO RELATED APPLICATION(S)

This application is the national phase of PCT Application No. PCT/EP2017/057655 filed on Mar. 31, 2017, which in turn claims priority to Netherlands Patent Application No. 102016000034943 filed on Apr. 5, 2016. These applications are incorporated by reference herein in their entirety.

### TECHNICAL FIELD

The present disclosure refers to a system and process for coating profiles and particularly to coating vertically conveyed aluminium profiles.

### BACKGROUND

As is known, current systems for treating profiles are constituted by several successive stations in which treatment of the surfaces of the profiles is carried out for the purpose of preparing them in an optimal manner for the coating process.

The profile coating process normally takes place inside a booth equipped for this purpose, using spray guns that dispense the electrostatically charged coating powder. Coating of good or bad quality depends on the shape of the booth, the type and the arrangement of the guns, the electrostatic charge of the powder coating, the type of suction for the residual powder, and numerous other important parameters.

For example, coating quality is closely linked to the physical characteristics of the profile, including the shape of the profile, that is, the shape of the section thereof that has recessed areas which are sometimes difficult to reach by the powder coating.

Moreover, the amount of powder that is deposited on a profile may be excessive or insufficient, as a function of the particular location the profile will have in the door or window frame.

To sum up, it can be stated that there are numerous variables that play a positive or negative role in obtaining a profile coating of good quality, with the result that the treatment, coating and coating polymerization parameters for the profiles are sometimes still selected based on experience and/or preliminary coating trials.

All of the above involves high costs due to wasted powder coating, coating defects, energy waste due to excessive temperatures in the polymerization ovens and excessive amounts of liquids for treatment of the profiles to prepare them for coating.

All of these drawbacks can essentially be traced back to the complexity of the section of the profiles, their length and the thickness of the surfaces thereof.

The drawbacks cited above are intensified in the case of a coating process for groups of profiles that differ from each other.

### SUMMARY

The task proposed by the present disclosure is to realize a system and process for coating profiles which make it possible to eliminate the drawbacks cited above concerning the prior art.

Within the scope of this task, an aim of the disclosure is to realize a system and process for coating profiles which make it possible to detect at least, but not only, the physical characteristics and shape of each profile for the purpose of managing the spray guns in an optimal manner during the coating procedure.

A further aim is to realize a system and process for coating profiles which make it possible to identify which parts of the profile to cover with a greater or smaller amount of coating, also as a function of its location in the door or window frame.

A further aim is to realize a system and process for coating profiles which make it possible to adjust the amount of coating and decide which type of coating to use.

A further aim is to realize a system and process for coating profiles which make it possible to precisely adjust the amount and type of washing and/or treatment products to be used on the profiles as preparation for the coating procedure.

A further aim is to realize a system and process for coating profiles which make it possible to optimize the polymerization oven temperatures.

This task, as well as the latter and other aims, are achieved by a system for coating profiles, comprising several treatment stations for treating the profiles, among which at least one coating station is equipped with spray guns for dispensing the electrostatically charged powder coating, characterized in that the system comprises first detection means for detecting first data concerning the dimensions and shape of said profiles, first storage media for storing second data concerning said powder coating, which shall be used for coating said profiles, second storage media for storing third data concerning a set of sample profiles, and comparison means for comparing said first, second and third data so as to generate commands adapted to vary the operating parameters for said guns.

In particular, the profile detection means can be positioned in the loading area (before the profiles are hooked to the conveyor chain) or after the profiles are hooked to the conveyor chain. In the first case, the hanging pitch can be obtained as a result of the characteristics of the profiles detected by the detection means. In one embodiment, the detection means comprise at least a first and a second optical detecting source positioned at opposite parts of the profiles so as to detect two images thereof, which are then superposed so as to exclude the image of the hooking element for hooking each profile to the conveyor chain.

The detection means detect the dimensions of the profiles so as to modify the hooking distance x between them along the conveyor chain, detect the thicknesses of the profiles so as to act upon respective members to modify the speed and the temperature of the polymerization oven, detect the complexity of the section so as to vary the pre-treatment and coating parameters for said profiles, and detect the coatable surface as a function of the end use of each profile so as to deposit greater or smaller amounts of coating on the various surfaces thereof.

The second data concerning the powder coating, which shall be used for coating said profiles, comprise the identification codes for the colour and type thereof.

The operating parameters for the guns comprise variation of the electrostatic charge and the pressure values for dispensing the powder from each gun, as well as the variation of the speed and the number of coats applied on said profiles by each one of said guns.

### BRIEF DESCRIPTION OF THE DRAWINGS

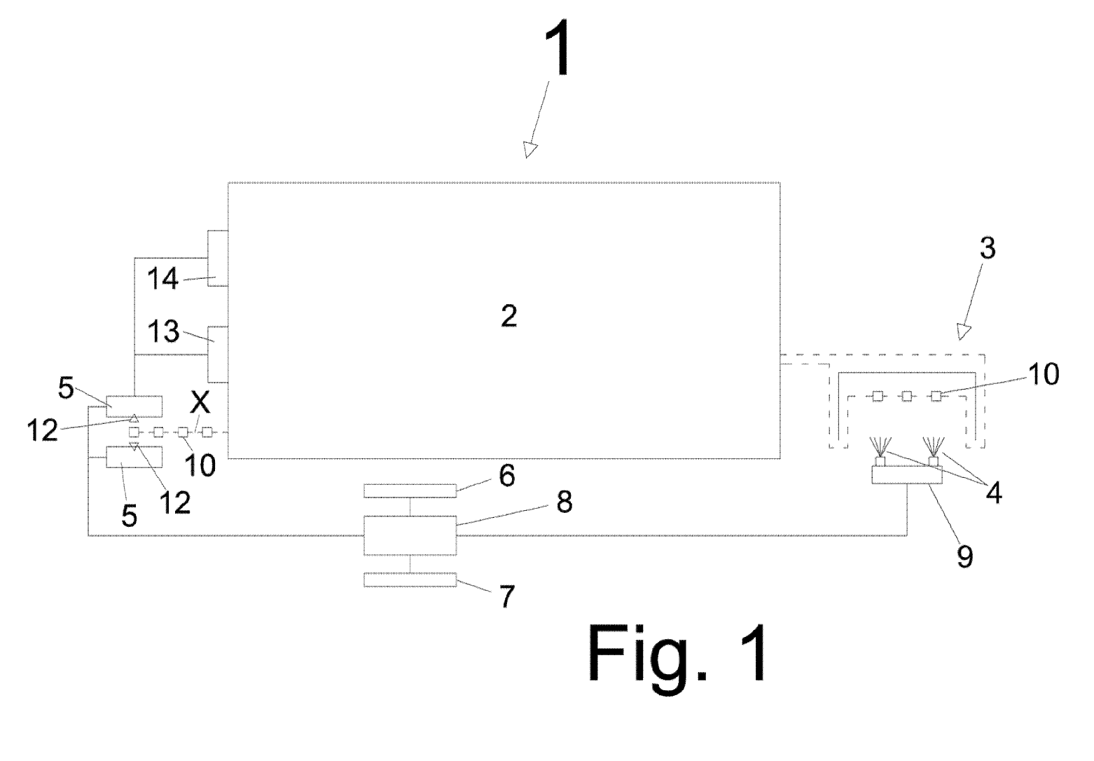

Further characteristics and advantages of the disclosure will become more apparent from the description of a preferred, but not exclusive, embodiment of a system for coating profiles according to the disclosure, which is illustrated by way of approximate and non-limiting example in the one drawing attached hereto, wherein: FIG. 1 is a schematic plan view of the system for coating profiles according to the disclosure.

### DETAILED DESCRIPTION

With particular reference to FIG. 1 described above, the system for coating profiles 10 is indicated in its entirety by the number 1.

The system 1 comprises several treatment stations 2 for treating the profiles 10, among which at least one coating station 3.

The coating station is equipped with spray guns 4 for dispensing the electrostatically charged powder coating.

Advantageously, the system has first detection means 5 by means of which it is possible to acquire first data concerning the dimensions and shape of the profiles 10. The system also has first storage media 6 containing second data concerning the powder coating that will be used for coating the profiles, and particularly the identification codes for the colour and the type of powder in the coating, and second storage media 7 containing third data concerning a set of sample profiles.

Owing to the comparison means 8 for comparing the first, second and third data, it is possible to generate new data, which, by means of the commands 9, enable continuous variation of the operating parameters for the guns.

With the continuous updating of these data, the system recreates the procedures by which the maximum possible efficiency is obtained for the application of the powder, avoiding the depositing of an excessive amount or, conversely, an insufficient amount on the profile.

In particular, the detection means 5 comprise at least a first and a second optical detecting source 12, for example two video cameras that are positioned at opposite parts of the profiles so as to detect two opposite images of each profile.

Subsequently, in the case in which the detection process is carried out on profiles that have already been hooked to the conveyor chain, the images obtained are superposed so as to exclude the shared image of the hooking element for hooking each profile to the conveyor chain, so as to obtain a real image only of the profile to be treated and coated.

In the case in which the detection process is carried out on profiles that have not yet been hooked to the conveyor chain, the exact dimensions of the profiles can be detected so as to modify as a result the distance X between one profile and the other, thereby obtaining optimal hooking of these profiles to the conveyor chain.

The detection means are capable of detecting the thicknesses of the profiles so as to act upon respective members 13 and 14 to modify the speed of the conveyor chain in the oven and the coating polymerization temperature in the oven, and the detection means are also capable of detecting the complexity of the section of the profiles so as to vary the pre-treatment and coating parameters for the profiles.

Moreover, by means of the detection means, it is possible to perform an additional, extremely important function, that is, that of detecting the coatable surface of the profiles as a function of their end use.

As an immediate result, this function makes it possible to adjust the parameters for the spray guns for spraying the powder and/or the electrostatic charge thereof, for each profile or group of profiles, so as to deposit greater or smaller amounts of coating on the various surfaces thereof.

For example, a greater amount of coating will be deposited on surfaces with greater exposure after installation of the profiles, whereas a smaller amount of coating will be deposited on the surfaces of the door or window frame that remain concealed or more protected, thereby optimizing the yield and consumption of the coating without negatively affecting the quality of the finished product.

Owing to the complete and precise identification of the physical characteristics and shape of each profile, it is possible to vary the electrostatic charge and the pressure values for dispensing the powder coating from each gun or group of guns and/or vary the speed of the guns and the number of coats applied on each profile by each one of the guns.

As observed above, a further object of the disclosure is also constituted by a process for coating profiles, comprising several steps of treating the profiles, among which at least one step of coating the profiles using spray guns for dispensing the electrostatically charged powder coating.

In particular, the process consists in detecting first data concerning the dimensions and shape of the profiles, in storing second data concerning the powder coating that shall be used for coating them, in storing third data concerning a set of sample profiles, and comparing the first, second and third data so as to generate commands adapted to vary the operating parameters for the guns.

Essentially, the process makes it possible to vary, upon entry of each profile into the coating booth, each one of the stored configurations that is modified in real time, using specific multipliers, based on a set of data, including the speed of the chain in the vertical system, the hooking pitch of the profiles and their length.

Moreover, for each individual profile passing through the various treatment stations of the system, additional data such as the area of section and its perimeter are detected in real time.

These data make it possible to generate the production statistics, which are very precise and thus correspond to real values, concerning data relative to the area and weight of the profiles actually coated.

The latter data can be obtained by combining the data cited above with the length of the profiles.

For example, the mass of the profile will correspond to the area of the section times the profile length and the specific weight of the aluminium.

The profile surface to be coated will correspond to the section of the external perimeter times the length of the profile.

The length of the profiles is estimated based on the length set for the vertical movement of the movable support of the guns.

By way of example, a more accurate evaluation of the length of the profiles can be obtained with the aid of a series of photocells located at various heights from the ground.

With the storage media, all the data concerning the system settings can be stored, including for example the values for the technical parameters, the temperatures, process times, the concentrations of chemical products for the pre-treatment, and other data as well, with reference to each production lot.

By integrating these stored data with the data for recognition of the individual profile, it is possible to implement traceability not only for the individual work order, but also for the individual profile.

In this manner, it will be possible to have a certificate of production and/or quality available for each piece produced.

Knowledge of the above-mentioned data enables them to be automatically uploaded for each profile.

Based on these data, the system will be automatically regulated according to the requirements of each profile, for example by receiving a database from the management software or by reading the profile code by means of a barcode reader. Moreover, integrating the various steps of the production process that takes place in the factory will be possible, with coating constituting one of such steps.

It will be possible to inform the purchasing department as to the amounts of coating powder utilized and to inform the production processes downstream of the system about the profiles that are actually passing through the coating system, such processes including custom cutting, the manufacturing of doors and windows, packaging and shipping.

It will be possible to print a label for each profile when it is unloaded from the system.

Once it has been applied on the profile, the label can represent useful information for the end use of the product.

Thanks to the data concerning the actual area and weight of the profiles in transit, the processes taking place along the system can be correctly calibrated.

For example, in the pre-treatment stations, the dosage of the chemical products in the treatment baths, that is, the dosage of the products that result in a reaction on the surface of the profile, must be proportional to the surface of the profile exposed to the pre-treatment.

Within the scope of given operating conditions, the renewal flow rates in the washing stages, like the discharge flow rates for the baths concentrated towards the purification area, are related to the surface of the profiles that are being treated.

In particular, the concentration of aluminium in the pre-treatment baths can successfully be kept constant.

The coating powder dispensed by the guns and thus the setting of the flow rate of the powder through the guns, reflects the amount of the aluminium surface to be covered. Not least, it is specified that the shape of the cross section of each profile or of the first profile in the case of one lot of profiles all having the same section, would be submitted to the system by the operator.

Once recognition of this section has taken place, the system could indicate in which point of section the operator can make the hole for hooking it to the conveyor and, as a result, the position in which to hook the profile by means of the support hook.

In this manner, all the profiles having the same section would arrive inside the booth in the most appropriate position possible in terms of the results of the application of the powder.

In an automated solution, once the section has been acquired, the correct position of the hole for the support hook for each profile would be communicated to an automatic drilling system.

In this case, the process of hooking the profile onto the line would be a completely automatic process.

In the case of a system in which the treatment liquid for treating the profiles is dispensed from above from special dispensing tanks, it is possible to vary, based on the dimensions of the cross section of the profile, the flow rate of the pump equipped with an inverter, which supplies the tanks, and the geometry of the blade of water dispensed from each tank could be modified, adapting it to the dimensions of the section of the profile.

In this manner, the blade of wash water can reach all the profiles, striking them in the same position in an optimal manner.

In a like manner, based on the geometry and weight/thickness of the profiles in transit, it will be possible to vary the burner power level: in preparation for an increase in the weight of the profiles in transit in the oven or in the event of profiles of large thicknesses, thus requiring longer heating and cooling processes, as a precautionary measure the burner is brought to a power level such as to compensate for the expected drop in temperature.

It will also be possible to vary the flow rate of the fans equipped with a motor with an inverter, as a function of the geometry of the profiles, focusing particularly on the geometries most sensitive to the air flows, thus enabling better control over the air flows that cause oscillation of the profiles in transit and possibly defects, due to the profiles striking against each other or against the walls of the oven.

The system and the process according to the disclosure also make it possible to vary the inclination of the deflectors, again as a function of the geometry of the profiles, inside the oven, so as to vary the air flows related to their geometry.

The system and process thus conceived for coating profiles is susceptible to numerous modifications and variants, all of which falling within the scope of the inventive concept. Moreover, all details may be replaced with other technically equivalent elements.

The materials used, as well as the dimensions, may in practice be of any type, according to needs and the state of the art.

1. A system for coating profiles, comprising several treatment stations for treating the profiles, including at least one coating station equipped with spray guns for dispensing electrostatically charged powder coating, wherein the system comprises:
first detection means for detecting first data concerning dimensions and shape of said profiles,
first storage media for storing second data concerning said powder coating, usable for coating said profiles,
second storage media for storing third data concerning a set of sample profiles, and
comparison means for comparing said first, second and third data so as to generate commands adapted to vary the operating parameters for said guns.

2. The system for coating profiles according to claim 1, wherein said detection means comprises at least a first and a second optical detecting source positioned at opposite parts of said profiles.

3. The system for coating profiles according to claim 2, wherein said first and second optical detecting source detect two images of each one of said profiles and said images are superposed so as to exclude an image of a hooking element for hooking each profile to a conveyor chain.

4. The system for coating profiles according to claim 1, wherein said detection means detects the dimensions of said profiles so as to modify a hooking distance x between said profiles along a conveyor chain.

5. The system for coating profiles according to claim 1, wherein said detection means detects thicknesses of said profiles so as to act upon respective members to modify a speed of a conveyor chain and a temperature of a polymerization oven.

6. The system for coating profiles according to claim 1, wherein said detection means detects a complexity of a section so as to vary pre-treatment and coating parameters for said profiles.

7. The system for coating profiles according to claim 1, wherein said detection means detects a coatable surface as a function of an end use of a section bar so as to deposit greater or smaller amounts of coating on various surfaces thereof.

8. The system for coating profiles according to claim 1, wherein said second data concerning said powder coating, usable for coating said profiles, comprises identification codes for a color and powder type of said coating.

9. The system for coating profiles according to claim 1, wherein said operating parameters for said guns comprise variation of electrostatic charge and pressure values for dispensing said powder from each one of said guns.

10. The system for coating profiles according to claim 1, wherein said commands are adapted to vary the operating parameters for said guns, including variation of a speed of the guns along the profiles and a number of coats applied on said profiles by each one of said guns.

11. A process for coating profiles, comprising several steps of treating the profiles, including at least one step of coating the profiles using spray guns for dispensing electrostatically charged powder coating, wherein the process further comprises:
detecting first data concerning dimensions and shape of said profiles,
storing second data concerning the powder coating that shall be used for coating said profiles,
storing third data concerning a set of sample profiles, and
comparing said first, second and third data so as to generate commands adapted to vary operating parameters for said guns.

12. The process for coating profiles according to claim 11, wherein detecting the first data is performed by at least a first and a second optical detecting source positioned at opposite parts of said profiles so as to detect two images of each one of said profiles, and said images are superposed so as to exclude an image of a hooking element for hooking the profile to a conveyor chain.

13. The process for coating profiles according to claim 11, wherein detecting the first data comprises detecting the dimensions of said profiles so as to modify a hooking distance between said profiles along a conveyor chain.

14. The process for coating profiles according to claim 11, wherein detecting the first data comprises detecting thicknesses of said profiles so as to modify a speed of a conveyor chain and a temperature of a polymerization oven.

15. The process for coating profiles according to claim 11, wherein detecting the first data comprises detecting a complexity of a section so as to vary pre-treatment and coating parameters for said profiles.

16. The process for coating profiles according to claim 11, wherein detecting the first data comprises detecting a coatable surface as a function of an end use of a section bar so as to deposit greater or smaller amounts of coating on various surfaces thereof.

17. The process for coating profiles according to claim 11, wherein said second data concerning said powder coating, which shall be used for coating said profiles, comprises identification codes for a color and type of powder in said coating.

18. The process for coating profiles according to claim 11, wherein said operating parameters for said guns comprise variation of electrostatic charge and pressure values for dispensing said powder from each one of said guns.

19. The process for coating profiles according to claim 11, wherein said operating parameters for said guns include variation of a speed of the guns along the profiles and a number of coats applied on said profiles by each one of said guns.
